(19) United States
(12) Patent Application Publication
(10) Pub. No.: US 2023/0017992 A1
(43) Pub. Date: Jan. 19, 2023

(54) SYSTEMS AND METHODS FOR IMPROVED DETERMINATION OF INSURANCE DATA

(71) Applicant: STATE FARM MUTUAL AUTOMOBILE INSURANCE COMPANY, Bloomington, IL (US)

(72) Inventors: Philip Sangpil Moon, Bloomington, IL (US); Jeannette Marie Haines, Bloomington, IL (US); Leo R. Bakel, Atlanta, GA (US); Alexander Buzzell, Bloomington, IL (US)

(21) Appl. No.: 17/586,712

(22) Filed: Jan. 27, 2022

Related U.S. Application Data
(60) Provisional application No. 63/221,443, filed on Jul. 13, 2021.

(51) Int. Cl. G06Q 40/08

(52) U.S. Cl. CPC G06Q 40/08

(57) ABSTRACT

The following relates generally to producing improved determination of insurance data. In some implementations, one or more processors performs a method including: receiving data (e.g., age and gender) of the customers of a household. The one or more processors may further analyze the data (e.g., age and gender) of each insurance customer to determine a household risk relativity, wherein the household risk relativity is operable to be input into a model to determine at least one of: an insurance premium, a loss ratio, a lapse rate, a claim frequency, an accident or claim severity, a pure premium, an automobile mileage driven, claim related expenses, and/or a telematics score.

### CROSS-REFERENCE TO RELATED APPLICATIONS

This application claims the benefit of U.S. Provisional Application No. 63/221,443 (filed Jul. 13, 2021), the entirety of which is incorporated by reference herein.

### FIELD

The present disclosure generally relates to improved determination of insurance forecasts, and more particularly relates to determining risk for households having one or more insureds.

### BACKGROUND

Many current systems for determining automobile insurance rates are designed to determine an appropriate insurance rate for a single driver of each vehicle. However, current systems that attempt to determine insurance rates for multiple drivers of shared vehicles run the risk of producing suboptimal insurance rates and/or have other drawbacks.

The systems and methods disclosed herein provide improvements and solutions to these problems, and may provide solutions to other drawbacks of conventional techniques.

### SUMMARY

The present embodiments may be related to improved determination of insurance data. For instance, the disclosure herein provides, inter alia, systems and methods for improved determination of an insurance premium, a loss ratio, a lapse rate, a claim frequency, an accident or claim severity, a pure premium, an automobile mileage driven, claim related expenses, a telematics score, a claim frequency, an accident or claim severity, a pure premium, an automobile mileage driven, claim related expenses, and/or a telematics score.

In one aspect, a computer-implemented method for use in improved determination of insurance data may be provided. The method may include, via one or more local or remote processors, transceivers, servers, and/or sensors: (1) receiving data (e.g., age and gender) of a first insurance customer of a household; (2) receiving data (e.g., age and gender) of a second insurance customer of the household; and (3) analyzing: (i) the data (e.g., age and gender) of the first insurance customer, and/or (ii) the data (e.g., age and gender) of the second insurance customer to determine a household risk relativity, wherein the household risk relativity is operable to be input into a model to determine at least one of: an insurance premium, a loss ratio, or a lapse rate. The method may include additional, less, or alternate actions, including those discussed elsewhere herein.

In another aspect, a computer system for use in improved determination of insurance data may be provided. The computer system may include one or more local or remote processors, servers, transceivers, and/or sensors configured to: (1) receive data (e.g., age and gender) of a first insurance customer of a household; (2) receive data (e.g., age and gender) of a second insurance customer of the household; and/or (3) analyze: (i) the data (e.g., age and gender) of the first insurance customer, and (ii) the data (e.g., age and gender) of the second insurance customer to determine a household risk relativity, wherein the household risk relativity is operable to be input into a model to determine at least one of: an insurance premium, a loss ratio, or a lapse rate. The computer system may include additional, less, or alternate functionality, including that discussed elsewhere herein.

In another aspect, a computer device for use in improved determination of insurance data may be provided. The computer device may include: one or more local or remote processors, servers, transceivers, and/or sensors; and one or more memories coupled to the one or more local or remote processors, servers, transceivers, and/or sensors. The one or more memories may include computer executable instructions stored therein that, when executed by the one or more processors, cause the one or more processors to: receive data (e.g., age and gender) of a first insurance customer of a household; receive data (e.g., age and gender) of a second insurance customer of the household; and analyze: (i) the data (e.g., age and gender) of the first insurance customer, and/or (ii) the data (e.g., age and gender) of the second insurance customer to determine a household risk relativity, wherein the household risk relativity is operable to be input into a model to determine an insurance premium. The computer system may further include additional, less, or alternate functionality, including that discussed elsewhere herein.

Advantages will become apparent to those skilled in the art from the following description. For instance, the techniques disclosed herein allow for a more accurate automobile insurance premium calculation in the situation where a household has more than one driver per vehicle. A further advantage of the systems and methods disclosed herein is that the insurance premiums for insurance customers are more consistent as the variable values increment (e.g., they tend not to rise at one age, and then fall the next), which is a result at least of the smoothing techniques disclosed herein. Further advantages will become apparent to those of ordinary skill in the art from the following description.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The Figures described below depict various aspects of the applications, methods, and systems disclosed herein. It should be understood that each Figure depicts an embodiment of a particular aspect of the disclosed applications, systems and methods, and that each of the Figures is intended to accord with a possible embodiment thereof. Furthermore, wherever possible, the following description refers to the reference numerals included in the following Figures, in which features depicted in multiple Figures are designated with consistent reference numerals.

FIG. 1 shows an exemplary computer system in accordance with the techniques described herein.

FIG. 2 shows a block diagram of a broad overview of an exemplary embodiment.

FIG. 3 illustrates a messaging diagram of an exemplary scenario.

FIG. 4 illustrates an exemplary variable curve.

FIG. 5 illustrates a flowchart of an exemplary computer-implemented method.

FIG. 6 illustrates a flowchart of an exemplary computer-implemented method including a more detailed illustration of analyzing the data (e.g., age and gender).

### DETAILED DESCRIPTION

The present embodiments relate to, inter alia, producing improved determination of insurance forecasts. For instance, as will be further described below, some embodiments use certain aspects of data (e.g., age and gender) to produce improved data for insurance premiums, loss ratios, and/or lapse rates.

Currently, systems for determining automobile insurance rates are designed to determine an appropriate insurance rate for a single driver of each vehicle. Yet, current systems that attempt to determine insurance rates for multiple drivers of shared vehicles run the risk of producing suboptimal insurance rates and/or have other drawbacks.

For example, it is not straightforward to determine an appropriate insurance premium for a vehicle with multiple drivers based upon the data (e.g., age and gender) of the drivers. For instance, simply averaging the age of the drivers does not necessarily produce an appropriate result. For example, an automobile insurance policy with two 40-year-old drivers may have a different level of risk from another policy with one 30-year-old driver and one 50-year-old driver, even though the average age is the same.

Furthermore, current systems for determining insurance premiums for multiple drivers of a single vehicle are also hindered because historical exposure and loss data are not always tracked by driver. Some embodiments of the present invention overcome this drawback by not relying on historical exposure or loss data for a single driver when calculating insurance premiums.

Embodiments of the present invention overcome these drawbacks and others. For instance, some implementations: first, estimate relative risk levels of drivers by age and gender using a multi-variate model; second, prepare the estimates to meet the business needs while optimizing for the best driver age curve; and finally, combine individual driver relative risk levels into one household estimate for a given vehicle.

As used herein, the term “insurance customer” refers to a customer of an insurance company, such as an insured named on an insurance policy. However, the term “insurance customer” does not necessarily refer to a named insured. For instance, “insurance customer” may refer to a driver in a household where the household has an insurance policy that the driver is not named on.

### Example Infrastructure

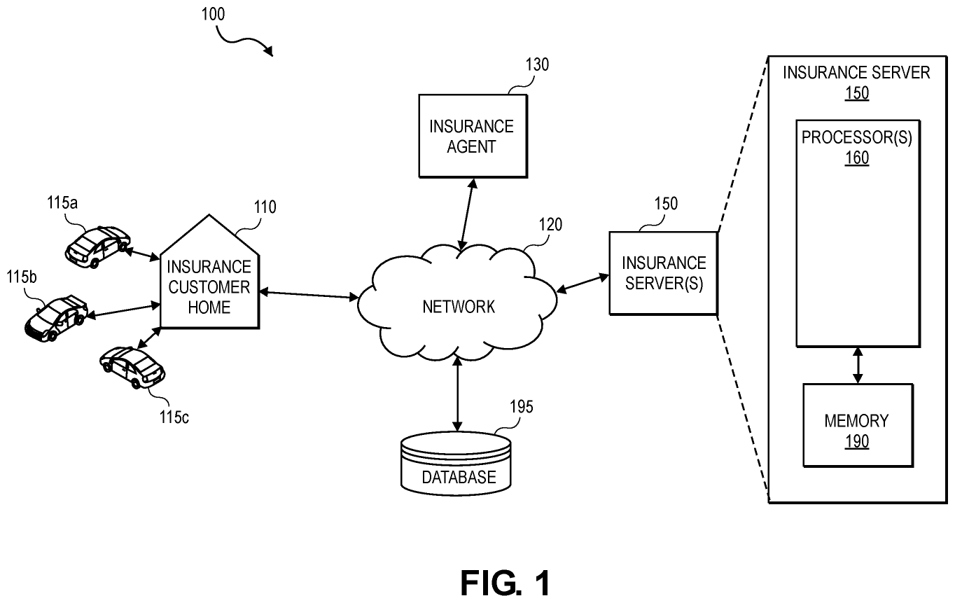

FIG. 1 shows an exemplary embodiment of the computer systems and computer-implemented methods disclosed herein. The example system 100 of FIG. 1 illustrates insurance server 150, insurance agent 130, insurance customer home 110, cars 115a, 115b, 115c, and database 195, any or all of which may be connected by network 120.

In this regard, in some embodiments, the techniques described herein may be used to calculate insurance data, such as insurance premiums, loss ratios, and/or lapse rates for insurance customers of the home 110. For instance, the insurance server 150 may calculate an automobile insurance premium for any or all of vehicles 115a, 115b, 115c. In addition, it should be noted that although the example of FIG. 1 illustrates the vehicles 115a, 115b, 115c as cars, any kind of (or combination of kinds of) vehicles could be contemplated (e.g., motorcycles, boats, motorhomes, etc.). Furthermore, although the example of FIG. 1 illustrates three vehicles 115a, 115b, 115c, any number of vehicles may be used in accordance with the techniques described herein. In addition, it should be understood that the insurance customer home 110 may be a current or prospective customer of an insurance agency of the insurance agent 130. Put another way, people of the insurance customer home 110 may simply be requesting an insurance quote from the insurance agent 130, and are not necessarily current customers of the insurance company of the insurance agent 130.

It should be understood that the term server as used herein may mean a single server or a group of servers. As is understood in the art, each server(s) includes processor(s) and memory. In the example of FIG. 1, the insurance server 150 includes processor(s) 160 and memory 190. As is understood in the art, the processor(s) 160 may be a single processor or a group of processors. Furthermore, software running on the processor(s) 160 may be implemented on a single processor or group of processors.

The network 120 may comprise a packet based network operable to transmit computer data packets among the various devices and servers described herein. For example, computer network 120 may consist of any one or more of Ethernet based network, a private network, a local area network (LAN), and/or a wide area network (WAN), such as the Internet. In addition, in some embodiments, computer network 120 may comprise cellular or mobile networks to facilitate data packet traffic (e.g., mobile device movement data), including, for example, any of GSM, UMTS, CDMA, NMT, LTE, 5G NR, or the like.

The network 120 may facilitate communication between any of the entities illustrated in the example of FIG. 1. For instance, the insurance server 150 may communicate an insurance premium to the insurance agent 130; and the insurance agent 130 may then communicate the insurance premium to the insurance customer home 110.

The server 150 may access data stored in the database 195 or write data to database 195 when executing various functions and tasks associated with the systems and methods described herein. For instance, the server 150 may access data from the database 195 to perform data processing on the data. In addition, although the example of FIG. 1 illustrates only one database 195, any number of databases may be used in accordance with the techniques described herein.

### Broad Overview of an Exemplary Technique

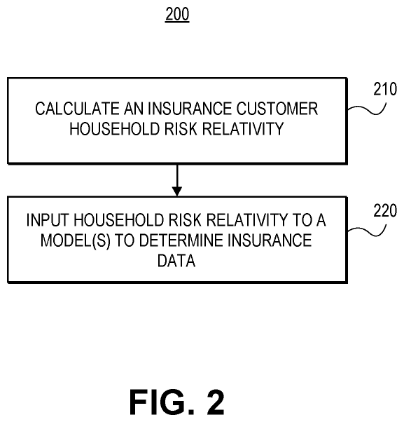

Very broadly speaking, some embodiments use a two-step process to determine insurance data, as illustrated in the exemplary computer-implemented-method 200 of FIG. 2.

At block 210 an insurance customer household relativity to risk may be determined (e.g., for insurance customer household 110). In some embodiments, the insurance customer household relativity to risk is determined from data (e.g., age and gender) of insurance customers of an insurance customer household.

Subsequently, at block 220, the determined insurance customer household relativity to risk is input into a statistical model(s) to determine insurance results (e.g., an insurance premium, a loss ratio, and/or a lapse rate).

To illustrate by way of example, in an insurance customer home 110 there may be four drivers and three vehicles. All of the drivers are different ages; and all of the vehicles are different types of vehicles. In this example, at block 210, an insurance customer household risk relativity would be determined from the data (e.g., age and gender) of the four drivers. Then, at block 220, the determined insurance customer household risk relativity could be input into a statistical model (once for each vehicle of the household) to determine an insurance premium for each of the vehicles.

### Example Implementations

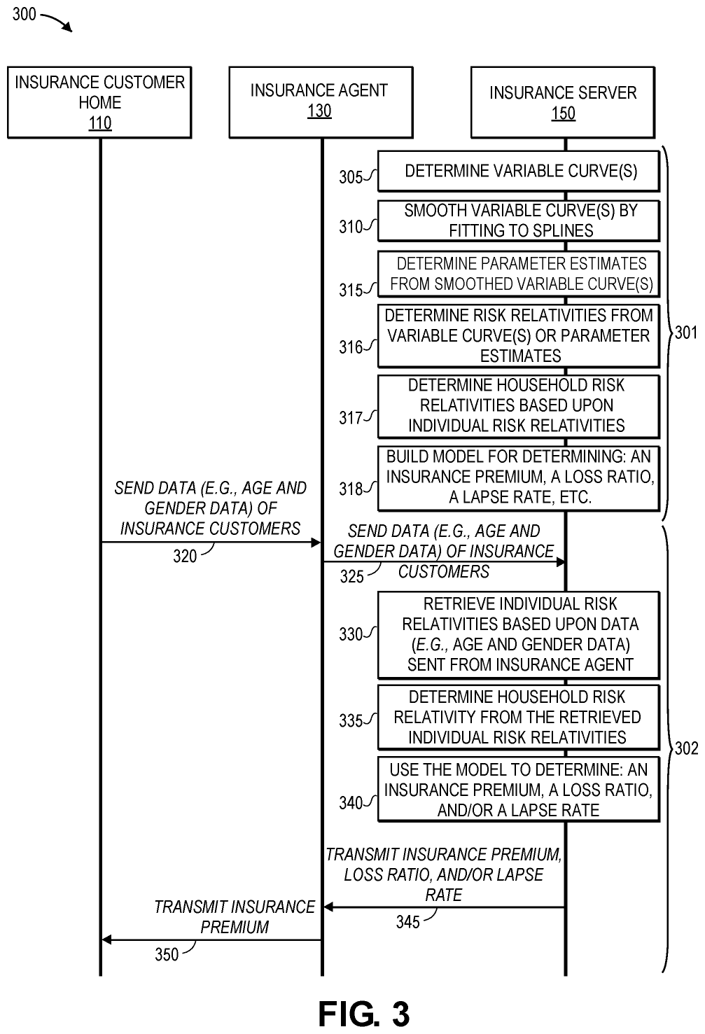

FIG. 3 illustrates a diagram of an exemplary scenario 300 of determining an insurance premium, a loss ratio, and/or a lapse rate. It should be understood that the scenario 300 is an example, and that not every embodiment must include each event illustrated in the example; likewise, some embodiments include additional events not illustrated in the example scenario 300. Moreover, it may be noted that additional components may perform the events of the figure. For instance, some of the events illustrated in the example scenario 300 as performed by the insurance server 150 may instead be performed by separate server(s) in a cloud computing arrangement.

Broadly speaking, the example of FIG. 3 may be considered to have two phases: an analytics phase 301 (including events 305, 310, 315, 316, 317, and 318), and a production phase 302 (including events 320, 325, 330, 335, 340, 345, and 350). At event 305, the insurance server 150 determines variable curve(s) (e.g., age curve(s), or gender curve(s)) based upon data (e.g., age and gender) either already in the memory 190, or retrieved from a database, such as the database 195. The variable curve(s) may further be determined based upon insurance data of bodily injury liability coverage, property damage liability coverage, comprehensive coverage, collision coverage, no-fault personal injury protection coverage, and/or medical payments coverage. In some embodiments, the determined variable curve(s) are then stored in the memory 190 or the database 195.

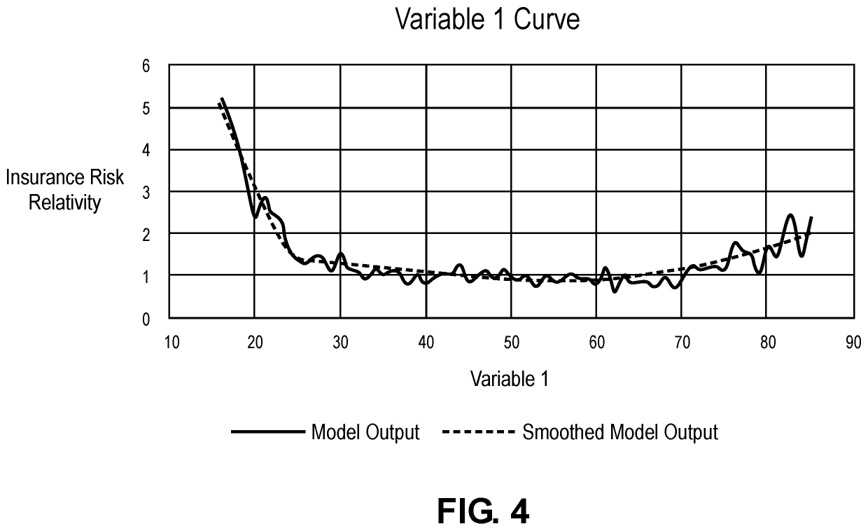

In some implementations, and as will be further described below, the variable curve is used to determine an insurance risk relativity from a variable of the insurance customer (e.g., the age of the customer). In this regard, FIG. 4 shows an example variable curve according to a generalized linear model (GLM) (e.g., the smoothed model output illustrated in FIG. 4). It may be noted that although the example of FIG. 4 illustrates a GLM, any suitable statistical model may be used.

However, in other embodiments, rather than directly determine the insurance risk relativity, the variable curve is used to determine a parameter estimate; and the parameter estimate may then in turn be used to determine a risk relativity of the individual insurance customer. The parameter estimate may correspond to any suitable parameter. For instance, in automobile insurance claims, the parameter estimate may correspond to insurance data of: bodily injury liability coverage, property damage liability coverage, comprehensive coverage, collision coverage, personal injury protection coverage and/or medical payments coverage.

In some embodiments, the variable curve may be created from data of a parameter(s) (e.g., bodily injury, property damage, comprehensive coverage, collision coverage, and/or medical payments coverage, etc.), a gender, and age using a multi-variate technique. Any suitable multi-variate technique may be used to create the variable curve (e.g., a GLM technique, a neural network or other Artificial Intelligence (AI) technique). In some embodiments, different data may correspond to different jurisdictions, and the variable curve may be further based upon data of a particular a jurisdiction (e.g., Ohio data is used for Ohio insurance customers, whereas Texas data is used for Texas customers). Furthermore, some jurisdictions prohibit use of age. In this regard, some embodiments, rather than age of insurance customer, use licensed number of years (e.g., a number of years that a driver has had her driver's license).

At event 310, the variable curve(s) are then smoothed. For instance, as illustrated in the example of FIG. 4, the “raw” variable curve (which may be created using a multi-variate technique, and is illustrated as smoothed model output in the example of FIG. 4) may be smoothed to create the spline applied curve. As a practical matter, smoothing the raw curve is useful because (as can be seen in the example of FIG. 4) the raw data of the model output might include deviations between adjacent ages, which might cause unnecessary insurance premium swings as drivers age. The variable curves may be smoothed (e.g., fitted to a spline, etc.) by any suitable technique. For instance, to find an optimal spline, the number and locations of knots, as well as the degrees of polynomials curves, may be varied. Additionally or alternatively, a R-squared or Root Mean Square Error (RMSE) may be used as a selection criterion.

At event 315, an individual parameter estimate may be obtained for each insurance customer of the insurance customer home 110. In this regard, to determine the parameter estimate(s) some embodiments use the smoothed variable curve, whereas other embodiments use the raw variable curve.

At event 316, the parameter estimates may be used to determine risk relativities of the individual insurance customers. For instance, in some embodiments, the risk relativity of the individual insurance customer may be:

individual risk relativity=exp(individual parameter estimate)

At event 317, household risk relativities may be determined based upon the individual risk relativities. In some embodiments, this is done by averaging the individual risk relativities (e.g., by taking a weighted sum of the individual risk relativities with an inverse of the number of individuals as weights). In one example, where the smoothed variable curve was used to determine the risk relativity, and with three household insurance customers, this may be illustrated as:

$$household risk relativity = \frac{1}{3} * s m o o t h e {d}_{-} d r i v e {r}_{-} r e {l}_{-} 1 + \\ \frac{1}{3} * s m o o t h e {d}_{-} d r i v e {r}_{-} r e {l}_{-} 2 + \frac{1}{3} smoothe {d}_{-} d r i v e {r}_{-} r e {l}_{-} 3$$

In this way, the isolated individual risk relativities are effectively combined into a household risk relativity.

Moreover, performing the averaging at this stage advantageously improves determination of insurance premiums. To explain, and for example, an automobile insurance policy with two 40-year-old drivers has different risk characteristics from another policy with one 30-year-old driver and one 50-year-old driver. Thus, averaging the household ages prior to determining a variable curve might result in a less accurate insurance premium determination. In contrast to that example, performing the averaging on the individual risk relativities, as disclosed herein, advantageously improves accuracy of insurance premium determination.

At event 318, a statistical model may be built that uses the parameter estimates, individual risk relativities, and/or household risk relativities to determine an insurance premium, loss ratio and/or lapse rate. The statistical model may be built by any suitable technique. In some embodiments, the statistical model is the model that will be used to determine the insurance data (e.g., the insurance premium, loss ratio and/or lapse rate) at block 220 in the example of FIG. 2. As will be explained further below, once built, the statistical model may take any suitable inputs to determine the insurance premium, loss ratio and/or lapse rate. For instance, the statistical model may directly take data (e.g., age and gender data) as inputs. Additionally or alternatively, the inputs to the statistical model may be parameter estimates, individual risk relativities, and/or household risk relativities.

Because, in some embodiments, this statistical model is used to calculate an insurance premium or other insurance data, this statistical model is sometimes referred to herein as a policy model. In some sense, the policy model is a “larger” model than the models that are used to create and smooth the variable curves because of the large multitude of factors or variables that the policy model may include. For example, the policy model may calculate an insurance premium based upon: a type of automobile (e.g., make and/or model); year of the automobile; mileage of the automobile; an accident or insurance claim history of any or all of the insurance customers of the insurance customer home 110 (e.g., an accident free status); a moving violation history; credit attributes; and/or other factors of any or all of the insurance customers of the insurance customer home 110. Any suitable factors may be input as variables into the policy model to determine an insurance premium, a loss ratio, and/or a lapse rate. The policy model may comprise any suitable model (e.g., a supervised or unsupervised learning algorithm; a neural network; a deep learning algorithm; etc.).

Subsequently, the example 300 proceeds to the production phase 302. In this phase, the events performed during the analytics phase (e.g., the building of the statistical model) are leveraged to produce useful information (e.g., an insurance quote for a specific customer or a specific insurance customer home 110).

At event 320, an insurance customer of insurance customer home 110 transmits gender and age data to the insurance agent 130 (e.g., the gender and age of any or all of the people in the insurance customer home 110). This may be done for purposes of requesting an insurance quote (e.g., for an automobile insurance policy, a homeowners insurance policy, an umbrella policy, etc.).

At event 325, the insurance agent 130 sends the data (e.g., age and gender) to the insurance server 150.

From here, the goal may be to use the data received by the insurance server 150 to calculate the insurance data (e.g., calculate an insurance quote to send to the insurance agent to provide to an insurance customer). To this end, in some embodiments, the data (e.g., age and gender) received by the insurance server at event 325 may be directly input into the statistical model (e.g., the example 300 proceeds directly to event 340 without performing events 330 or 335).

However, in other embodiments, individual risk relativities and/or household risk relativities may be used as inputs to the statistical model. As such, at event 330, the insurance server 150 may use the data (e.g., age and gender) to retrieve individual risk relativities (e.g., from a variable curve (e.g., by using the techniques described above). And, at event 335, the retrieved individual risk relativities may be used to determine a household risk relativity (e.g., using the techniques described above.

At event 340, the statistical model is used to determine an insurance premium, a loss ratio, a lapse rate, a claim frequency, an accident or claim severity, a pure premium, an automobile mileage driven, claim related expenses, a telematics score, etc. In some embodiments, the accident or claim severity may comprise a numerical rating of the accident or claim severity. In some embodiments, the telematics score may comprise a numerical rating of a driver or vehicle performance based upon telematics data (e.g., data gathered from the vehicle). As mentioned above, the statistical model may take, as inputs, the data (e.g., age and gender), parameter estimates, individual risk relativities, and/or household risk relativities.

In addition, some statistical models (e.g., policy models) may be used for more than one vehicle; and, in some embodiments, may take account a number of vehicles in the model. For instance, a policy model may be run to determine a single insurance premium that would cover three vehicles; and, in some implementations, this policy model would take into account the number of vehicles (three) in calculating the insurance premium.

In some embodiments, the statistical model may calculate an insurance premium for a homeowners insurance policy. In some implementations of this, the household risk relativity may be calculated at event 335 similarly as for the embodiments that calculate an automobile insurance premium. Then, the policy model (e.g., at event 340) may calculate the premium for the homeowners insurance policy based upon: the household risk relativity; square footage of the house; construction materials of the house; year the house was built; prior insurance claims of individuals of the insurance customer home; geographic location of the home; inspection report details of a home; other physical characteristics of the home (e.g., if the home has a basement); and/or other factors.

In some embodiments, the statistical model may calculate an insurance premium for an umbrella insurance policy. In some implementations of this, the household risk relativity may be calculated at event 335 similarly as for the embodiments that calculate an automobile insurance premium. Then, the policy model (e.g., at event 340) may calculate the premium for the umbrella insurance policy based upon: a dollar amount of insurance coverage that the umbrella policy will provide; a number of other insurance policies held by individuals of the insurance customer home; the types of insurance policies held by individuals of the insurance customer home; premium amounts of the other insurance policies held by the individuals of the insurance customer home; information of previous insurance claims made by the individuals of the insurance customer home; other information of the other insurance policies held by the individuals of the insurance customer home; and/or other factors.

In some implementations, at event 340, instead of or in addition to the insurance premium other calculations or predictions may be made. For instance, a loss ratio, lapse rate, a claim frequency, an accident or claim severity, a pure premium, an automobile mileage driven, claim related expenses, and/or a telematics score may be calculated or predicted. In this regard, it should be understood that a first policy model may be used to calculate the insurance premium, a second policy model may be used to calculated the loss ratio, a third policy model may be used to calculate the lapse rate, and other policy model(s) may be used to calculate the claim frequency, the accident or claim severity, the pure premium, the automobile mileage driven, the claim related expenses, and/or the telematics score.

In some embodiments, the loss ratio comprises the losses an insurer may incur due to paid claims as a percentage of premiums earned. To calculate the loss ratio, in addition to the household risk relativity, the policy model may take as inputs: premium payment history of individuals of the insurance customer home; premium payment history of other insurance customers; claims history of individuals of the insurance customer home; claims history of other insurance customers; and/or other factors.

In some embodiments, the lapse rate comprises a percentage of an insurance company's policies that have not been renewed by customers, such as individuals of the insurance customer home. To calculate the lapse rate, in addition to the household risk relativity, the policy model may take as inputs: information of individuals of the insurance customer home (e.g., income, occupation, geographic location, types of insurance policies owned, length of time insurance policies have been owned, premium payment history, claims history, etc.), and/or other factors.

At event 345, the insurance premium, loss ratio, lapse rate, and/or any other calculations/predictions made at event 340 may be transmitted from the insurance server 150 to the insurance agent 130. At event 350, the insurance premium (e.g., in the form of an insurance quote) is transmitted from the insurance agent 130 to the insurance customer home 110.

### Exemplary Methods

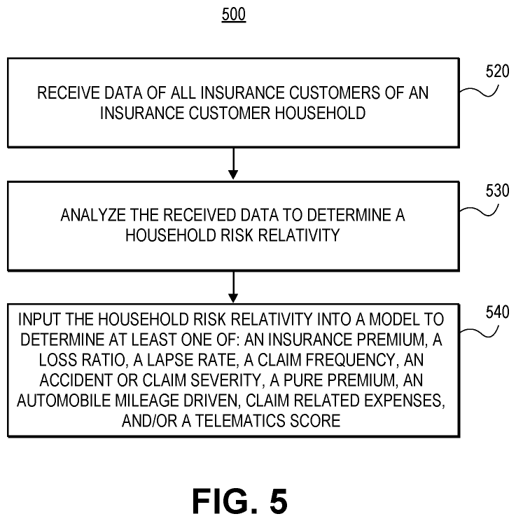

FIG. 5 illustrates a flow diagram of an exemplary insurance data determination method 500, which may be implemented by the insurance data determination system 100. It should be understood that the computer-implemented method 500 is an example, and that not every embodiment must include each block illustrated in the example; likewise, some embodiments include additional blocks not illustrated in the exemplary method 500. In some embodiments, the exemplary method 500 is performed by the insurance server 150. However, it should be understood that any component or combination of components illustrated in the insurance data determination system 100 may perform any or all of the exemplary method 500.

At block 520, data (e.g., age and gender) of insurance customers (e.g., of the insurance customer household 110) is received (e.g., at the insurance server 150). It should be understood that the data may be of any number of insurance customers. Furthermore, in some embodiments, the insurance customers need not be of the same household; for example, drivers from different homes that will drive the same vehicle may have their age and gender information sent.

At block 530, the insurance server 150 analyzes the received data (e.g., age and gender) of the insurance customers. In some embodiments, this comprises retrieving a variable curve (such as that in the example of FIG. 4; the variable curves may be retrieved from the memory 190 and/or the database 195) to determine individual risk relativities or parameter estimates for the individual insurance customers for which data was received. In some embodiments, the parameter estimates may be used to calculate risk relativities of the insurance customers. Next, the risk relativities of the first and second insurance customers may be used to calculate a household risk relativity.

Subsequently, at block 540, the household risk relativity may be input into a model (e.g., a policy model) to determine at least one of: an insurance premium, a loss ratio, a lapse rate, a claim frequency, an accident or claim severity, a pure premium, an automobile mileage driven, claim related expenses, and/or a telematics score. It should be understood that, in some embodiments, block 540 corresponds to block 230 of FIG. 2.

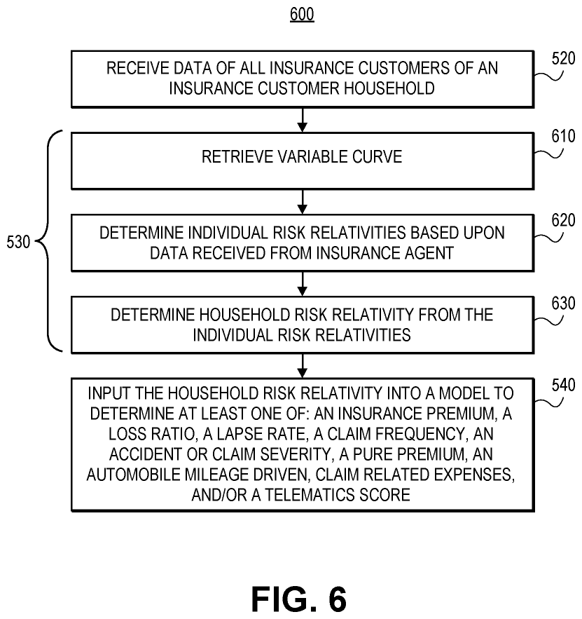

FIG. 6 illustrates a flow diagram of an exemplary insurance data determination method 600, which may be implemented by the insurance data determination system 100. The example of FIG. 6 includes a somewhat more detailed illustration of analyzing the data (e.g., age and gender) than in FIG. 5. It should be understood that the computer-implemented method 600 is an example, and that not every embodiment must include each block illustrated in the example; likewise, some embodiments include additional blocks not illustrated in the exemplary method 600. In some embodiments, the exemplary method 600 is performed by the insurance server 150. However, it should be understood that any component or combination of components illustrated in the insurance data determination system 100 may perform any or all of the exemplary method 600.

With reference to FIG. 6, block 520 is performed similarly to as in FIG. 5. Then, at 530, an analysis is performed by analyzing the received data (e.g., age and gender) of the insurance customers. In some embodiments, this begins by, at block 610, retrieving a pre-smoothed variable curve (such as the example smoothed variable curve of FIG. 4) corresponding to the first insurance customer. The variable curve may be retrieved from the memory 190, the database 195, and/or any other suitable source. Alternatively, an unsmoothed variable curve may be retrieved. The variable curve may then be smoothed according to any suitable technique. For instance, a R-squared, RMSE, or goodness of fit may be used as a selection criterion. Furthermore, any number of variable curves may be retrieved regardless of whether they are pre-smoothed or unsmoothed.

At block 620, individual risk relativities are determined based on the data (e.g., age and gender) received at block 520. For instance, the individual risk relativities may be determined by referencing the variable curve(s) retrieved at block 610 with data (e.g., age and gender).

At block 630, the insurance server 150 may determine a household risk relativity from the risk individual relativities of the insurance customers.

Block 540 is performed similarly as in FIG. 5. That is, the household risk relativity is input into a model to determine at least one of: an insurance premium, a loss ratio, and/or a lapse rate. In some embodiments, this corresponds to block 220 of FIG. 2.

### Exemplary Functionality

In one aspect, a computer-implemented method for use in improved determination of insurance data may be provided. The method may include, via one or more processors: (1) receiving data (e.g., age and gender) of a first insurance customer of a household; (2) receiving data (e.g., age and gender) of a second insurance customer of the household; and/or (3) analyzing: (i) the data (e.g., age and gender) of the first insurance customer, and (ii) the data (e.g., age and gender) of the second insurance customer to determine a household risk relativity, wherein the household risk relativity is operable to be input into a model to determine at least one of: an insurance premium, a loss ratio, and/or a lapse rate. The method may include additional, less, or alternate actions, including those discussed elsewhere herein.

For instance, the analyzing: (i) the data (e.g., age and gender) of the first insurance customer, and (ii) the data (e.g., age and gender) of the second insurance customer may be done according to a generalized linear model (GLM). Additionally or alternatively, the analyzing: (i) the data (e.g., age and gender) of the first insurance customer, and (ii) the data (e.g., age and gender) of the second insurance customer may be done according to a neural network (NN).

In some embodiments, the method further comprises determining the household risk relativity by referencing a variable curve with the data of the first insurance customer and the data of the second insurance customer.

In some embodiments, the household risk relativity may be operable to be input into the model to determine the insurance premium; and the insurance premium may be an automobile insurance premium.

In some embodiments: the household risk relativity comprises a relativity to risk of an insurance claim; the household risk relativity is operable to be input into the model to determine the insurance premium; and the computer-implemented method further comprises, via the one or more processors: inputting the determined household risk relativity into the model to determine the insurance premium based upon (i) the determined household risk relativity, and (ii): a type of insurance risk (e.g., automobile boat, etc.); an accident or insurance claim history of the first insurance customer; an accident or insurance claim history of the second insurance customer; a moving violation history of the first insurance customer; a moving violation history of the second insurance customer; and/or other relevant data.

The household risk relativity may comprise a relativity to risk of an automobile accident or insurance claim; the model may be an automobile insurance policy model; the household risk relativity may be operable to be input into the model to determine the insurance premium; and the insurance premium may comprise an automobile insurance premium. The computer-implemented method may further include, via the one or more processors, inputting the determined household risk relativity into the automobile insurance policy model to determine the automobile insurance premium based upon (i) the determined household risk relativity, and (ii): a type of automobile; an accident or insurance claim history of the first insurance customer; an accident or insurance claim history of the second insurance customer; a moving violation history of the first insurance customer; and/or a moving violation history of the second insurance customer, along with other input data.

The household risk relativity may be operable to be input into the model to determine the insurance premium. And the insurance premium may be for one of, for instance: a homeowners insurance policy, a life insurance policy, or an umbrella insurance policy.

In some embodiments, the household risk relativity may be operable to be input into the model to determine the insurance premium; the insurance premium may comprise a first automobile insurance premium; the model may be a first an automobile insurance policy model corresponding to a first type of automobile of the household. And the computer-implemented method may further include, via the one or more processors: inputting the household risk relativity to the first model to determine the first automobile insurance premium; and inputting the household risk relativity to a second automobile insurance policy model to determine a second automobile insurance premium for a second automobile of the household, wherein the second automobile insurance policy model corresponds to the second automobile of the household.

The analyzing: (i) the data (e.g., age and gender) of the first insurance customer, and (ii) the data (e.g., age and gender) of the second insurance customer to determine a household risk relativity may further include: determining a parameter estimate of the first insurance customer of the household based upon the received data (e.g., age and gender) of the first insurance customer; determining a parameter estimate of the second insurance customer of the household based upon the received data (e.g., age and gender) of the second insurance customer; determining a risk relativity of the first insurance customer of the household based upon the parameter estimate of the first insurance customer of the household; determining a risk relativity of the second insurance customer of the household based upon the parameter estimate of the second insurance customer of the household; and determining the household risk relativity based upon: (i) the risk relativity of the first insurance customer of the household, and (ii) risk relativity of the second insurance customer of the household.

The determining the household risk relativity may include averaging the risk relativity of the first insurance customer of the household and the risk relativity of the second insurance customer of the household.

In some embodiments, the method further comprises: determining a variable curve from a generalized linear model or a neural network; smoothing the variable curve by fitting a spline while using a R-squared, Root Mean Square Error, or a goodness of fit as a selection criterion; and determining the household risk relativity by referencing the smoothed variable curve.

In some embodiments, the household risk relativity comprises a relativity to risk of an automobile insurance claim; and the variable curve is determined from the statistical model, and the statistical model is based upon insurance data of: bodily injury liability coverage, property damage liability coverage, comprehensive coverage, collision coverage, no-fault personal injury protection coverage, and/or medical payments coverage.

In another aspect, a computer system for use in improved determination of insurance data may be provided. The computer system may include one or more processors configured to: (1) receive data (e.g., age and gender) of a first insurance customer of a household; (2) receive data (e.g., age and gender) of a second insurance customer of the household; and/or (3) analyze: (i) the data (e.g., age and gender) of the first insurance customer, and (ii) the data (e.g., age and gender) of the second insurance customer to determine a household risk relativity, wherein the household risk relativity is operable to be input into a model to determine at least one of: an insurance premium, a loss ratio, and/or a lapse rate. The one or more processors may be local or remote to the household or house and/or to the insurance provider, and may include one or more processors, servers, transceivers, sensors, smart sensors, and/or other components. The computer system may include additional, less, or alternate functionality, including that discussed elsewhere herein.

The analysis of: (i) the data (e.g., age and gender) of the first insurance customer, and (ii) the data (e.g., age and gender) of the second insurance customer may be done according to a statistical model (e.g., a generalized linear model) or neural network.

The household risk relativity may be operable to be input into the model to determine the insurance premium; and the insurance premium may be an automobile insurance premium.

The one or more processors may be further configured to analyze: (i) the data (e.g., age and gender) of the first insurance customer, and (ii) the data (e.g., age and gender) of the second insurance customer to determine a household risk relativity by: determining a parameter estimate of the first insurance customer of the household based upon the received data (e.g., age and gender) of the first insurance customer; determining a parameter estimate of the second insurance customer of the household based upon the received data (e.g., age and gender) of the second insurance customer; determining a risk relativity of the first insurance customer of the household based upon the parameter estimate of the first insurance customer of the household; determining a risk relativity of the second insurance customer of the household based upon the parameter estimate of the second insurance customer of the household; and determining the household risk relativity based upon: (i) the risk relativity of the first insurance customer of the household, and (ii) risk relativity of the second insurance customer of the household.

In another aspect, a computer device for use in improved determination of insurance data may be provided. The computer device may include: one or more local or remote processors; and one or more memories coupled to the one or more processors. The one or more memories may include computer executable instructions stored therein that, when executed by the one or more processors, cause the one or more processors to: receive data (e.g., age and gender) of a first insurance customer of a household; receive data (e.g., age and gender) of a second insurance customer of the household; and analyze: (i) the data (e.g., age and gender) of the first insurance customer, and/or (ii) the data (e.g., age and gender) of the second insurance customer to determine a household risk relativity, wherein the household risk relativity is operable to be input into a model to determine an insurance premium. The computer system may further include additional, less, or alternate functionality, including that discussed elsewhere herein.

The analysis of: (i) the data (e.g., age and gender) of the first insurance customer, and (ii) the data (e.g., age and gender) of the second insurance customer may be done according to a generalized linear model (GLM).

The instructions, when executed by the one or more processors, may further cause the one or more processors to analyze: (i) the data (e.g., age and gender) of the first insurance customer, and (ii) the data (e.g., age and gender) of the second insurance customer to determine a household risk relativity by: determining a parameter estimate of the first insurance customer of the household based upon the received data (e.g., age and gender) of the first insurance customer; determining a parameter estimate of the second insurance customer of the household based upon the received data (e.g., age and gender) of the second insurance customer; determining a risk relativity of the first insurance customer of the household based upon the parameter estimate of the first insurance customer of the household; determining a risk relativity of the second insurance customer of the household based upon the parameter estimate of the second insurance customer of the household; and/or determining the household risk relativity based upon: (i) the risk relativity of the first insurance customer of the household, and (ii) risk relativity of the second insurance customer of the household.

In some implementations, the instructions, when executed by the one or more processors, may further cause the one or more processors to: determine a variable curve from a generalized linear model or neural network; smooth the variable curve by using a spline while using a R-squared, Root Mean Square Error, or goodness of fit technique as a selection criterion; and determine the household risk relativity by referencing the smoothed first variable curve.

### OTHER MATTERS

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those skilled in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for use in improved determination of insurance results, the method comprising, via one or more processors:
receiving data of a first insurance customer of a household;
receiving data of a second insurance customer of the household; and
analyzing: (i) the data of the first insurance customer, and (ii) the data of the second insurance customer to determine a household risk relativity, wherein the household risk relativity is operable to be input into a model to determine at least one of: an insurance premium, a loss ratio, or a lapse rate.

2. The computer-implemented method of claim 1, wherein the analyzing: (i) the data of the first insurance customer, and (ii) the data of the second insurance customer is done according to a modeling technique.

3. The computer-implemented method of claim 1, the received data of the first insurance customer being age and gender data of the first insurance customer; and
the received data of the second insurance customer being age and gender data of the second insurance customer.

4. The computer-implemented method of claim 1, further comprising:
determining the household risk relativity by referencing a variable curve with the data of the first insurance customer and the data of the second insurance customer.

5. The computer-implemented method of claim 1, wherein:
the household risk relativity is operable to be input into the model to determine the insurance premium.

6. The computer-implemented method of claim 1, wherein:
the household risk relativity comprises a relativity to risk of an insurance claim;
the household risk relativity is operable to be input into the model to determine the insurance premium; and
the computer-implemented method further comprises, via the one or more processors:
inputting the determined household risk relativity into the model to determine the insurance premium based upon (i) the determined household risk relativity, and (ii):
a type of insurance risk;
an accident or insurance claim history of the first insurance customer;
an accident or insurance claim history of the second insurance customer;
a moving violation history of the first insurance customer;
a moving violation history of the second insurance customer; and/or
other relevant data.

7. The computer-implemented method of claim 1, wherein:
the household risk relativity is operable to be input into the model to determine the insurance premium; and
the insurance premium is for one of: a homeowners insurance policy, a life insurance policy, or an umbrella insurance policy.

8. The computer-implemented method of claim 1, wherein:
the household risk relativity is operable to be input into the model to determine the insurance premium;
the insurance premium comprises a first automobile insurance premium;
the model is a first an automobile insurance policy model corresponding to a first type of automobile of the household; and
the computer-implemented method further comprises, via the one or more processors:
inputting the household risk relativity to the first model to determine the first automobile insurance premium; and
inputting the household risk relativity to a second automobile insurance policy model to determine a second automobile insurance premium for a second automobile of the household, wherein the second automobile insurance policy model corresponds to the second automobile of the household.

9. The computer-implemented method of claim 1, wherein the analyzing: (i) the data of the first insurance customer, and (ii) the data of the second insurance customer to determine a household risk relativity comprises:
determining a parameter estimate of the first insurance customer of the household based upon the received data of the first insurance customer;
determining a parameter estimate of the second insurance customer of the household based upon the received data of the second insurance customer;
determining a risk relativity of the first insurance customer of the household based upon the parameter estimate of the first insurance customer of the household;
determining a risk relativity of the second insurance customer of the household based upon the parameter estimate of the second insurance customer of the household; and
determining the household risk relativity based upon: (i) the risk relativity of the first insurance customer of the household, and (ii) risk relativity of the second insurance customer of the household.

10. The computer-implemented method of claim 9, wherein the determining the household risk relativity comprises averaging the risk relativity of the first insurance customer of the household and the risk relativity of the second insurance customer of the household.

11. The computer-implemented method of claim 1, further comprising:
determining a variable curve from a statistical model or a neural network;
smoothing the variable curve while using a R-squared, Root Mean Square Error, or goodness of fit as a selection criterion; and
determining the household risk relativity by referencing the smoothed variable curve.

12. The computer-implemented method of claim 11, wherein:
the household risk relativity comprises a relativity to risk of an automobile insurance claim; and
the variable curve is determined from the statistical model, and the statistical model is based upon insurance data.

13. A computer system for use in improved determination of insurance data, the computer system comprising one or more processors configured to:
receive data of a first insurance customer of a household;
receive data of a second insurance customer of the household; and
analyze: (i) the data of the first insurance customer, and (ii) the data of the second insurance customer to determine a household risk relativity, wherein the household risk relativity is operable to be input into a model to determine at least one of: an insurance premium, a loss ratio, or a lapse rate.

14. The computer system of claim 13, wherein the analysis of: (i) the data of the first insurance customer, and (ii) the data of the second insurance customer is done according to a model comprising either a statistical model or neural network.

15. The computer system of claim 13, wherein:
the household risk relativity is operable to be input into the model to determine the insurance premium.

16. The computer system of claim 13, wherein the one or more processors are further configured to analyze: (i) the data of the first insurance customer, and (ii) the data of the second insurance customer to determine a household risk relativity by:
determining a parameter estimate of the first insurance customer of the household based upon the received data of the first insurance customer;
determining a parameter estimate of the second insurance customer of the household based upon the received data of the second insurance customer;
determining a risk relativity of the first insurance customer of the household based upon the parameter estimate of the first insurance customer of the household;
determining a risk relativity of the second insurance customer of the household based upon the parameter estimate of the second insurance customer of the household; and
determining the household risk relativity based upon the risk relativities of each of the first and second insurance customers of the household.

17. A computer device for use in improved determination of insurance data, the computer device comprising:
one or more processors; and
one or more memories coupled to the one or more processors;
the one or more memories including computer executable instructions stored therein that, when executed by the one or more processors, cause the one or more processors to:
receive data of a first insurance customer of a household;
receive data of a second insurance customer of the household; and
analyze the data of each of the first and second insurance customers to determine a household risk relativity, wherein the household risk relativity is operable to be input into a model to determine at least one of: an insurance premium, a loss ratio, or a lapse rate.

18. The computer device of claim 17, wherein the analysis of: (i) the data of the first insurance customer, and (ii) the data of the second insurance customer is done according to a model comprising a statistical model or neural network.

19. The computer device of claim 17, wherein the instructions, when executed by the one or more processors, further cause the one or more processors to analyze: (i) the data of the first insurance customer, and (ii) the data of the second insurance customer to determine a household risk relativity by:
determining a parameter estimate of the first insurance customer of the household based upon the received data of the first insurance customer;
determining a parameter estimate of the second insurance customer of the household based upon the received data of the second insurance customer;
determining a risk relativity of the first insurance customer of the household based upon the parameter estimate of the first insurance customer of the household;
determining a risk relativity of the second insurance customer of the household based upon the parameter estimate of the second insurance customer of the household; and
determining the household risk relativity based upon the risk relativities of each of the first and second insurance customers of the household.

20. The computer device of claim 19, wherein the instructions, when executed by the one or more processors, further cause the one or more processors to:
determine a variable curve from a statistical model or neural network;
smooth the variable curve using a R-squared, Root Mean Square Error, or goodness of fit technique as a selection criterion; and
determine the household risk relativity by referencing the smoothed first variable curve.
